(19) United States
(12) Patent Application Publication
(10) Pub. No.: US 2026/0252171 A1
(43) Pub. Date: Aug. 27, 2026

(54) XR DEVICE, CONTROLLER APPARATUS FOR XR DEVICE, AND OPERATING METHOD OF XR DEVICE USING SAME

(71) Applicant: LG ELECTRONICS INC., Seoul (KR)

(72) Inventors: Jaehyuk SEOL, Seoul (KR); Woosun KANG, Seoul (KR)

(73) Assignee: LG ELECTRONICS INC., Seoul (KR)

(21) Appl. No.: 18/992,030

(22) PCT Filed: Jul. 15, 2022
(86) PCT No.: PCT/KR2022/010406

§ 371 Date: Jan. 7, 2025

(51) Int. Cl. G06F 3/01

(52) U.S. Cl. CPC G06F 3/014; G06F 3/017

(57) ABSTRACT

An XR device disclosed in the present specification transmits/receives data by being connected to a controller worn on a hand of a user. Also, the XR device collects external environment information and tracks a position of the user through a first camera, and tracks a position of the hand of the user wearing the controller through a second camera. Also, the XR device displays a virtual object corresponding to the hand on a VR image corresponding to the collected external environment information, processes the virtual object corresponding to the hand to move on the VR image by tracking the position of the hand, and displays same.

### CROSS REFERENCE TO RELATED APPLICATIONS

This application is the National Phase of PCT International Application No. PCT/KR2022/010406, filed on Jul. 15, 2022, all of which is hereby expressly incorporated by reference into the present application.

### TECHNICAL FIELD

The present disclosure relates to an XR device, a controller apparatus for the XR device, and an operating method of the XR device using the same, and more specifically, to an XR device to which a tracking technology using a ToF camera is applied, a controller apparatus for the XR device, and an operating method of the XR device using the same.

### BACKGROUND ART

The provision of diverse services utilizing VR, AR, and MR technologies is expanding. VR technology provides a real-world object or background as a computer graphic image, AR technology overlaps a virtual computer graphic on a top of an actual object image to provides them together, and MR technology provides a combination of real-world and virtual objects on an equal footing. Furthermore, technology that includes all of the VR, AR, and MR technologies is also referred to as extended reality (XR) technology, or extended reality.

An apparatus to which the XR technology is applied may be referred to as an XR apparatus or XR device. The XR device may be implemented in various types, and in the case of a body-worn XR device, it is generally used in conjunction with an auxiliary input apparatus or controller.

Meanwhile, in the case of a conventional auxiliary input device or controller (hereinafter, ‘controller’), a plurality of infrared LED rings are mounted on the controller for position tracking. The infrared LED rings take up a significant portion of the controller, causing the controller to increase in size and weight.

In addition, the conventional controller is implemented in a state that requires a user to continuously grip the controller while using the controller. Accordingly, when performing a specific motion using the controller, for example, a motion operation for a scene where a virtual object is thrown, it is not only inconvenient to operate, but also often results in losing the grip of the controller. To this end, it is implemented in the form of including a hand strap in the controller, but even in this case, there is still an inconvenience in that the user has to maintain a grip state on the controller. Maintaining a grip state on the controller for a long period of time causes a problem such as increased user fatigue.

### DISCLOSURE OF INVENTION

### Technical Problem

An aspect of the present disclosure is to solve the foregoing and other problems.

According to some embodiments of the present disclosure, an aspect of the present disclosure is to provide a controller apparatus implemented to identify and track a position of a controller without having an LED ring on the controller, an XR device using the same, and an operating method thereof.

According to some embodiments of the present disclosure, an aspect of the present disclosure is to provide a controller apparatus capable of interacting with a virtual image/object provided on an XR device without gripping a controller, an XR device using the same, and an operating method thereof.

According to some embodiments of the present disclosure, an aspect of the present disclosure is to provide a controller apparatus capable of providing feedback related to interaction with a virtual image/object provided on an XR device through a controller, an XR device using the same, and an operating method thereof.

### Solution to Problem

To this end, an XR device according to the present disclosure may operate in conjunction with a controller having a wearable form on a user's hand, and the XR device may locate a position of the hand of the user wearing the controller, and detect a hand motion of the user wearing the controller to control the movement of a virtual hand object, thereby interacting with a virtual target object provided by the XR device. In addition, haptic/tactile sensation may be provided to the user through the controller when interacting with a virtual target object through a virtual hand object, thereby operating to achieve a more realistic and natural interaction.

The XR device disclosed herein is connected to a controller worn on a user's hand to transmit and receive data. Additionally, the XR device collects external environmental information and tracks a user's position through a first camera, and tracks a position of a hand of the user wearing the controller through a second camera. Furthermore, a virtual object corresponding to the hand is displayed on a VR image corresponding to collected external environment information, and the position of the hand is tracked to process and display the virtual object corresponding to the hand so as to move on the VR image. In addition, the XR device receives operation detection data corresponding to a motion of the hand as input from the controller, and displays a virtual object corresponding to the hand to perform a motion related to an interaction with a target object of the VR image based on the received input. Accordingly, the user does not need to continuously grip the controller while using the XR device, and the XR device does not need to be configured to track the position of the controller, allowing a more natural interaction.

Specifically, an XR device according to the present disclosure may include a communication module that transmits and receives data to and from a controller; a first camera for collecting external environment information and tracking a user's position and a second camera for tracking a position of a hand of the user wearing the controller; a display that displays a virtual object corresponding to the hand on a VR image corresponding to the collected external environment information; and a processor that tracks the position of the hand and processes the virtual object to move on the VR image so as to display the processed virtual object on the display. In addition, the processor may receive operation detection data corresponding to a motion of the hand as input from the controller through the communication module, and control the display to allow the virtual object to perform an interaction-related operation with a target object of the VR image based on the received input.

In an embodiment, the processor may control the display to display an interaction-related operation for a target object of the VR image while a feedback signal corresponding to the operation detection data is generated from the controller.

In an embodiment, the first camera may be a general camera and the second camera may be a ToF camera.

In an embodiment, the XR device may be a head-mounted display device that can be worn on the user's head, and when worn, the first camera may be positioned above both eyes of the user to scan a forward environment, and the second camera may be positioned below the both eyes of the user to track the hand of the user wearing the controller.

In an embodiment, the processor may control a point of the hand of the user wearing the controller to be captured through the second camera, control continuous images including a depth map of the user's hand to be acquired based on the captured point, and operate a virtual object corresponding to the hand to be displayed on the VR display based on the acquired continuous images.

In an embodiment, the received input may be either one of a first input and a second input, wherein the first input is operation detection data according to a motion of bending a hand wearing the controller, and the second input is operation detection data according to a motion of extending the hand, and the processor displays an operation that maintains the interaction when the first input is received and displays a motion that leaves the interaction when the second input is received.

In addition, a controller apparatus for an XR device may be configured to be worn on a user's hand, the control apparatus including a communication module that transmits and receives data when connected to the XR device; a sensor that detects a change in extension or contraction of a connected wire according to a motion of the hand of the user wearing the body; a processor that transmits operation detection data corresponding to a change in extension or contraction of the connected wire to the XR device based on the hand of the user wearing the body being recognized through a camera of the XR device so as to interact with a VR image displayed on the XR device; and an output module that outputs a feedback signal when an interaction with the VR image is performed based on the operation detection data.

In an embodiment, the sensor may detect, subsequent to wearing a ring, which is worn in a fitted form on the user's finger, while the ring and a wire wrapped around a wheel module are connected, wire extension corresponding to a motion of bending the finger or wire contraction corresponding to a motion of extending the finger, and transmit the detected wire extension or contraction to the processor.

In an embodiment, the controller apparatus may have a structure in which one end of the wire is connected to the ring, and the other end of the wire is wound in the form of a fixed cable around a torsion spring built into the wheel module, wherein the sensor operates to detect wire extension when the wire is withdrawn in a direction of the ring according to a motion of bending the finger, and detect wire contraction when the wire is withdrawn in a direction of the wheel module according to a motion of extending the finger.

In an embodiment, vibration feedback may be output through the output module while an operation of gripping a target object by a virtual object of the VR image is displayed based on the operation detection data.

In an embodiment, when an increase in wire extension is detected by the sensor while an operation of gripping a target object by a virtual object of the VR image is displayed, a level of vibration feedback output through the output module may be increased to transmit data related to the increase in wire extension to the XR device so as to display a feedback image around the target object of the VR image.

In an embodiment, when wire contraction is detected by the sensor while an operation of gripping a target object by a virtual object of the VR image is displayed, a level of vibration feedback output through the output module may be decreased to transmit data related to the wire contraction to the XR device so as to display a feedback movement for the target object of the VR image.

In addition, an operating method of an XR device may include connecting the XR device and a controller apparatus worn on a user's hand; recognizing the hand of the user wearing the controller apparatus through a camera of the XR device; detecting a change in extension or contraction of a connected wire according to a motion of the hand of the user wearing the controller apparatus; and displaying an interaction-related operation on a VR image displayed on the XR device in response to receiving operation detection data corresponding to the detected change in the extension or contraction of the wire.

### Advantageous Effects of Invention

The effects of a digital signage platform providing device and operating method, and a system including the same according to the present disclosure are described as follows.

According to some embodiments of the present disclosure, a position of a user's hand including a depth map may be identified and tracked through a ToF camera provided on an XR device, without the need to have an LED ring on a controller in conjunction with the XR device, thereby generating a virtual object for interaction. The LED ring that takes up a significant portion of the controller may be removed, thereby contributing to reducing the size and weight of the controller.

In addition, according to some embodiments of the present disclosure, a controller in conjunction with an XR device may be implemented in a hand-worn form rather than a grip form (i.e., a hand-held type), thereby eliminating the need for a user to continuously grip the controller while interacting with the XR device so as to free the user's hands and further facilitate operation. Moreover, the controller causes less fatigue even when used for a long period of time.

In addition, according to some embodiments of the present disclosure, when interacting with a target object provided through an XR device through a controller, feedback corresponding to a user's hand motion may be provided to the user's hand, thereby allowing the user to feel a more realistic interaction when interacting with a virtual object.

### BRIEF DESCRIPTION OF DRAWINGS

FIG. 1 is a block diagram showing an exemplary configuration of an XR device according to an embodiment of the present disclosure.

FIG. 2 is a view including an exemplary configuration and appearance of a controller communicating with an XR device according to an embodiment of the present disclosure.

FIGS. 3A, 3B, and 3C are views showing a wearing appearance and exemplary components when an XR device according to an embodiment of the present disclosure is implemented as an HMD type.

FIGS. 4A, 4B, 4C, and 4D are views for explaining a structure, exemplary components, and an operation of a controller communicating with an XR device according to an embodiment of the present disclosure.

FIG. 5 is a diagram for explaining an operation in which an XR device and a controller interact based on operation detection data from the controller according to an embodiment of the present disclosure.

FIGS. 6A and 6B are views for explaining an interaction operation displayed on a VR image of an XR device through tracking a hand of a user wearing a controller according to an embodiment of the present disclosure.

FIG. 7 is an operational flowchart associated with FIGS. 6A and 6B.

FIG. 8 is an exemplary flowchart for explaining an interaction operation displayed on a VR image of an XR device based on wire contraction detected by a controller according to an embodiment of the present disclosure.

FIG. 9 is an exemplary flowchart for explaining an interaction operation displayed on a VR image of an XR device based on an increase in wire contraction or wire extension detected by a controller according to an embodiment of the present disclosure.

### MODE FOR THE INVENTION

Hereinafter, embodiments of the present disclosure will be described in detail with reference to the accompanying drawings, and the same or similar elements are designated with the same numeral references regardless of the numerals in the drawings and redundant description thereof will be omitted. A suffix “module” or “unit” used for elements disclosed in the following description is merely intended for easy description of the specification, and the suffix itself is not intended to give any special meaning or function. In describing the embodiments disclosed herein, moreover, the detailed description will be omitted when specific description for publicly known technologies to which the invention pertains is judged to obscure the gist of the present disclosure. Furthermore, the accompanying drawings are provided only for a better understanding of the embodiments disclosed herein and are not intended to limit technical concepts disclosed herein, and therefore, it should be understood that the accompanying drawings include all modifications, equivalents and substitutes within the concept and technical scope of the present disclosure.

The terms including an ordinal number such as first, second, and the like may be used to describe various elements, but the elements should not be limited by those terms. The terms are used merely for the purpose to distinguish an element from another element.

It will be understood that when an element is referred to as being “connected to” or “coupled to” another element, the element can be directly connected to or coupled to the other element or intervening elements may also be present. On the contrary, it will be understood that when an element is referred to being “directly connected” or “directly coupled” to another element, there are no intervening elements present.

A singular representation may include a plural representation unless it represents a definitely different meaning from the context.

Terms “include” or “have” used herein should be understood that they are intended to indicate the presence of a feature, a number, a step, an element, a component or a combination thereof disclosed in the specification, and it may also be understood that the presence or additional possibility of one or more other features, numbers, steps, elements, components or combinations thereof are not excluded in advance.

Hereinafter, an “XR device” disclosed herein, which is an electronic device to which extended reality (XR) technology that collectively refers to VR, AR, and MR technologies is applied, may include various types of electronic devices that can analyze three-dimensional data acquired through various sensors or external devices to acquire information on a surrounding space or a real object, and based thereon, output an augmented reality image, an augmented reality object, and/or an augmented reality object rendered on a real object.

The XR device may be implemented in the form of, for example, a head-mounted display (HMD), a head-up display (HUD), a mobile phone, a tablet PC, a laptop, a desktop, a TV, a digital signage, or the like.

Hereinafter, a “controller,” “controller apparatus,” or “controller device” disclosed herein may refer to a device that is connected in a wireless/wired manner to an XR device to perform various inputs related to an operation of the XR device, a displayed image, a virtual object, or an interaction with a real object through the XR device.

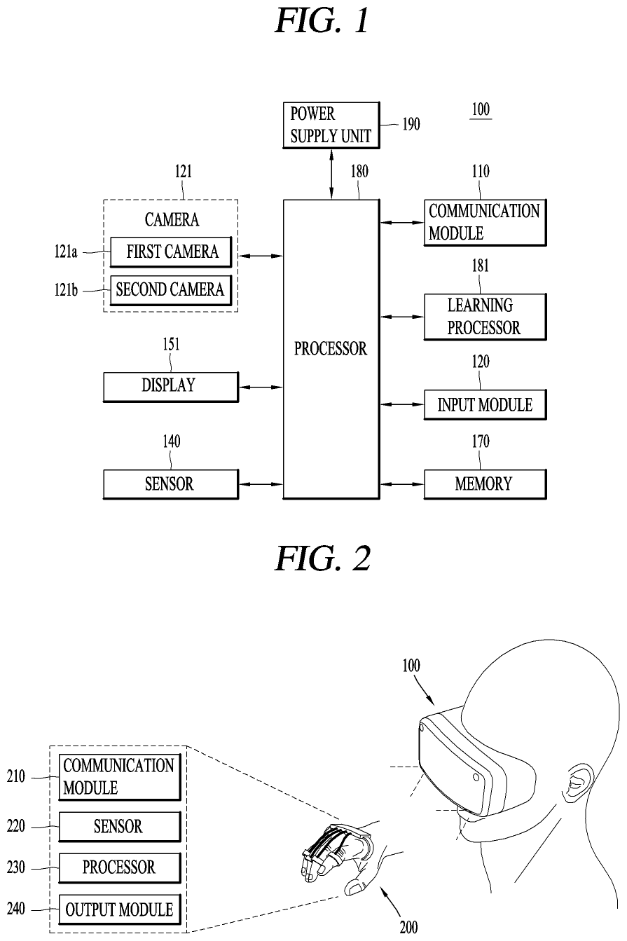

FIG. 1 is a block diagram showing an exemplary configuration of an XR device 100 according to an embodiment of the present disclosure.

Referring to FIG. 1, an XR device 100 according to the present disclosure may include a communication module 110, an input module 120, a camera 121, a sensor 140, a display 151, a memory 170, a processor 180, and a power supply unit 190. According to an embodiment, the XR device 100 may include only some of the elements described above or may include more elements.

The communication module 110 may perform wired/wireless communication with a controller 200 (FIG. 2), an external device, a server, and may communicate using wireless communication. Such wireless communications may include short-range wireless communication methods such as Wi-Fi and Bluetooth, and long-range wireless communication methods such as LTE using 3GPP communication standards.

The input module 120 may include a mechanical input element (e.g., a mechanical key, a button, a dome switch, a jog wheel, a jog switch, etc.) and a touch input element provided on the front, rear, or side of the XR device 100. In an embodiment, the touch input element may include a virtual key, a soft key, a visual key, a touch key displayed on a touch screen through software processing, and those keys may include, for example, a graphic, text, an icon, a video, or a combination thereof.

The input module 120 may further include a camera (hereinafter, described in the camera 121) that receives a video signal and a microphone that receives an audio signal.

The camera 121 may include a first camera 121a and a second camera 121b. Images acquired through the first camera 121a and the second camera 121b may respectively be converted into electrical signals, and respective images converted into electrical signals may be stored in the memory 170 or the like, or may be directly displayed on the display 151 through the processor 180.

The first camera 121a may capture a surrounding environment (e.g., a subject in front) of the XR device 100 and convert the captured image into an electrical signal, and based thereon, may identify a user's position and track the position. The second camera 121b may identify a position of the user's hand in conjunction with the XR device 100 and track the position.

According to an embodiment, the first camera 121a may refer to a general camera, and the second camera 121b may refer to a ToF camera. In addition, the first camera 121a and the second camera 121b may each be configured to include a plurality of units.

The ToF camera may refer to a time-of-flight (ToF) camera. The ToF technology is a technology that detects the position and depth of a subject by transmitting sound waves or light sources to the subject and measuring the time it takes for the reflected sound waves or light sources to pass through the subject and return. With the TOF technology applied to a ToF sensor, it is possible to measure the depth of an object positioned within a field of view of the ToF camera, and acquire a 3D-based result based thereon.

The first camera 121a and the second camera 121b may respectively have different angles of view and may detect an actual object positioned within each angle of view. The processor 180 may display a virtual object corresponding to an actual object positioned within the field of view through the display 151.

The sensor 140 may acquire at least one of information on an external device or the XR device 100, surrounding environment information around the XR device 100, and user information by using various sensors provided in the XR device 100.

The sensor 140 may be mounted inside or outside the XR device 100, and may include various sensors, such as, for example, a proximity sensor, an illuminance sensor, an acceleration sensor, a gravity sensor, a magnetic sensor, a geomagnetic sensor, a gyro sensor, an inertial sensor, an RGB sensor, an IR sensor, a fingerprint recognition sensor, an ultrasonic sensor, a light sensor, a microphone, a lidar, a radar, a motion sensor, an inclination sensor, a brightness sensor, an altitude sensor, an olfactory sensor, a temperature sensor, a depth sensor, a pressure sensor, a bending sensor, an audio sensor, a video sensor, a global positioning system (GPS) sensor, and a touch sensor.

In addition, the sensor 140 may further include a sensor for collecting three-dimensional point data, such as a portion of a user's body, for example, light detection and ranging (LIDAR), red green blue depth (RGBD), a 3D laser scanner, and the like.

The display 151 performs the role of displaying an image such as a VR image, a virtual object or the like, which is generated by the processor 180 for the user, and may be formed of a translucent material so as to allow an external environment to be viewed through an opening portion, for example.

The display 151 may operate in such a manner that the image generated by the processor 180 is projected through a guide lens. Specifically, an image such as a VR image, a virtual object generated by the processor 180 may be projected onto the display 151 through a plurality of lens modules that diffuse and converge light emitted from an image source of the processor 180.

The display 151 may be implemented as a liquid crystal display (LCD), a thin-film-transistor-liquid crystal display (TFT LCD), an organic light-emitting diode (OLED), a flexible display, a 3D display, an electro luminescent display (ELD), or a micro LED (m-LED).

The memory 170 may store data that supports various functions of the XR device 100. For example, the memory 170 may store surrounding environment information (subject image in front) acquired through the camera 121, data input through the input module 120, learning data, a learning model, a learning history, and the like, which are input through a learning processor 181.

Additionally, the memory 170 may store user information of the XR device 100 and information on the controller apparatus.

The processor 180 may control elements provided in the XR device 100 to perform an overall operation of the XR device 100. The processor 180 may generate a VR image, an image of a virtual object, and the like to be displayed through the XR device 100 and provide the generated image to the display 151.

The processor 180 may analyze three-dimensional point data or image data acquired through various sensors included in the sensor 140 or in conjunction with the controller 200 (FIG. 2) to acquire information on a surrounding space of the XR device 100 or a real object, and render a virtual object generated based on the acquired information so as to output the rendered virtual object through the display 151. For example, the processor 180 may render a virtual object including additional information on a real object recognized through the first camera 121a to overlap the real object and output the rendered virtual object to the display 151.

The processor 180 may operate in conjunction with a learning processor 181 provided internally or externally. The learning processor 181 may be implemented to perform an operation of the processor 180 using at least one data analysis algorithm, machine learning algorithm, or learning model consisting of an artificial neural network. According to an embodiment, the processor 180 may perform the above-described operation using a learning result from the learning processor 181.

The power supply unit 190 receives external power and internal power based on the control of the processor 180 and supplies power necessary for the operation of respective components of the XR device 100. The power supply unit 190 may include a rechargeable battery.

FIG. 2 is a view including an exemplary configuration and appearance of the controller 200 communicating with the XR device 100 according to an embodiment of the present disclosure. The controller 200 according to the present disclosure is connected to interact with the XR device 100 through wired/wireless communication.

The XR device 100 may be implemented in the form of glasses or close-fitting goggles worn on the user's face, as shown in FIG. 2. The XR device 100 may be connected to the controller 200 implemented in a form worn on a user's hand to interact therewith.

The controller 200 may include a communication module 210, a sensor 220, a processor 230, and an output module 240.

The communication module 210 of the controller 200 is configured to transmit and receive signals/data by communicating with the XR device 100 in a wired/wireless communication manner. When implemented in a wired communication manner, the communication module 210 includes one or more connection ports for cable connection, and when implemented in a wireless communication manner, it may communicate using a short-range wireless communication method such as Wi-Fi or Bluetooth.

The sensor 220 may include an operation detection sensor that detects a motion of a hand of a user wearing the controller 200. The operation detection sensor detects wire contraction when a user wearing the controller 200 performs a motion of bending a finger, and detects wire extension when the user performs a motion of extending his or her finger.

A signal/data corresponding to the wire contraction/extension detected through the operation detection sensor of the sensor 220 is transmitted as an input to the XR device 100 through the communication module 210 to perform an interaction with the device 100.

The processor 230 performs a connection between the XR device 100 and the controller 200, and performs an operation for interacting with the controller 200 itself and/or the XR device 100 based on a sensing result of the sensor 220 of the controller 200. According to an embodiment, the processor 230 may operate to receive a sensing result of an operation detection sensor of the sensor 220, transmit a signal/data corresponding to the received sensing result to the XR device 100, and output a feedback signal through the output module 240.

Hereinafter, a specific operation of the XR device 100 disclosed herein and the controller 200 in conjunction with the XR device 100 will be described in detail.

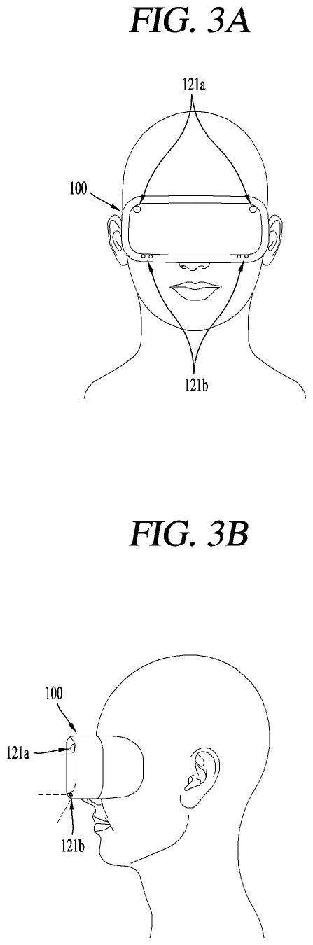

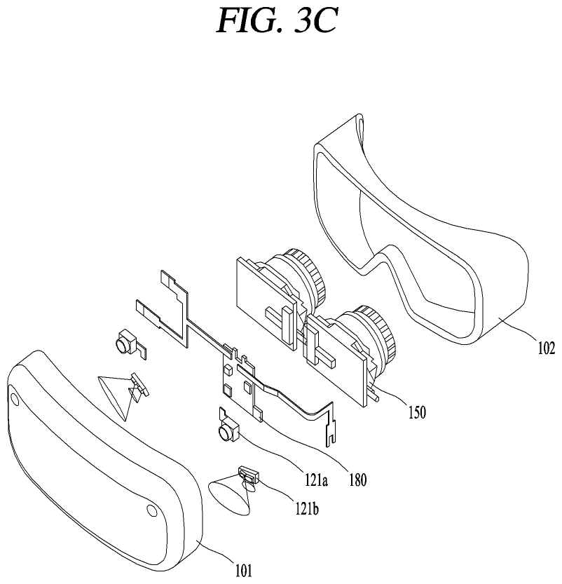

FIGS. 3A, 3B, and 3C are views showing a wearing appearance and exemplary components when an XR device according to an embodiment of the present disclosure is implemented as an HMD type.

As shown in FIGS. 3A and 3B, when the XR device 100 according to the present disclosure is implemented as an HMD type device, it may have a structure in which a general camera (hereinafter, ‘first camera’) 121a is positioned above both eyes of a user when worn, and a ToF camera (hereinafter, ‘second camera’) 121b is positioned below.

The first camera 121a is used to collect information on an external environment around the user and track a position of the user wearing the XR device.

The second camera 121b is used to track a hand position of the user wearing the controller in conjunction with the XR device.

The second camera 121b acquires an image of the user's hand shown within a field of view, including a depth map, through a ToF sensor mounted thereon. Here, the ToF sensor may project sound waves/light sources onto the user's hand (e.g., any point on the user's hand), and measure the time it takes for the reflected sound waves/light sources to bounce off the user's hand and return so as to generate a depth map for the user's hand. The depth map represents an image including information on a distance to a surface of the user's hand from a viewpoint.

The XR device 100 according to the present disclosure may acquire an original image for the user's hand, a depth map, and an image resulting from applying the depth map to the original image through the second camera 121b.

In addition, as described in detail below, since the controller 200 in conjunction with the XR device 100 is implemented in a form worn on the user's hand, tracking a position of the user's hand means tracking the position of the controller. Therefore, the XR device 100 may accurately implement the movement of a virtual object corresponding to the controller using only the second camera 121b. This will be described in more detail below.

In an embodiment, the first cameras 121a may be disposed respectively on upper left and right sides of a binocular reference to be suitable for collecting environment information around the user's field of vision. Additionally, the second cameras 121b may be disposed on lower left and right sides of the binocular reference to be suitable for tracking the position of a hand moving in a range below the user's face.

In still another embodiment, when the XR device is implemented in a form other than an HMD type, depending on the implemented type, the first cameras may be disposed at different positions suitable for tracking the user's position, and the second cameras may be disposed at different positions suitable for tracking the position of the user's hand.

Subsequently with reference to FIG. 3C, the XR device 100 may be implemented to include a front case 101, a face shield 102, and a lens module 150, a PCB 180, and cameras 121a, 121b therebetween.

As shown in FIG. 3C, the face shield 102 may be implemented in the form of goggles that fit closely around both eyes of the user, but is not limited thereto. The front case 101 may include an opening portion to view an image of a subject in front of both eyes.

Between the front case 101 and the face shield 102, first cameras 121a, second cameras 121b, a PCB circuit 180, and a lens module 150 may be sequentially built, and integrally disposed. The front case 101 and the face shield 102 may be formed of a flexible material to make it easy for the user to wear.

The PCB circuit 180 is a hardware implementation of the aforementioned processor 180, and the PCB and the processor in the XR device 100 may be used with the same meaning. The PCB circuit 180 may be used to generate an image or virtual object to be shown to the user wearing the XR device 100.

The lens module 150 may include a plurality of lenses, such as optical lenses and guide lenses, and may include a display formed of a translucent material to view an external environment through an opening portion of the front case 101. An image output through the display may be displayed to overlap the user's normal field of vision.

Additionally, although not shown in FIG. 3C, the XR device 100 may be provided with electronic components such as an audio output module, a microphone, and a communication module between the front case 101 and the face shield 102 or on the side of the XR device 100. Through the communication module of the XR device 100, the XR device 100 and the controller 200 described below are communicably connected to each other.

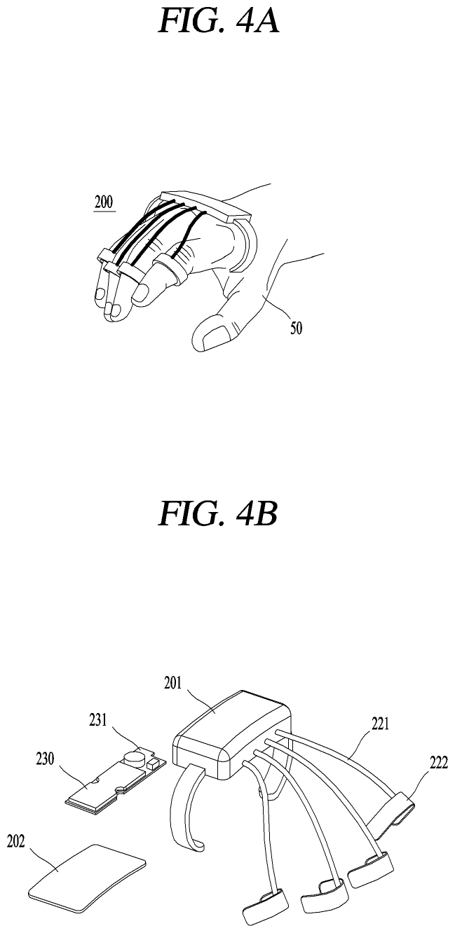

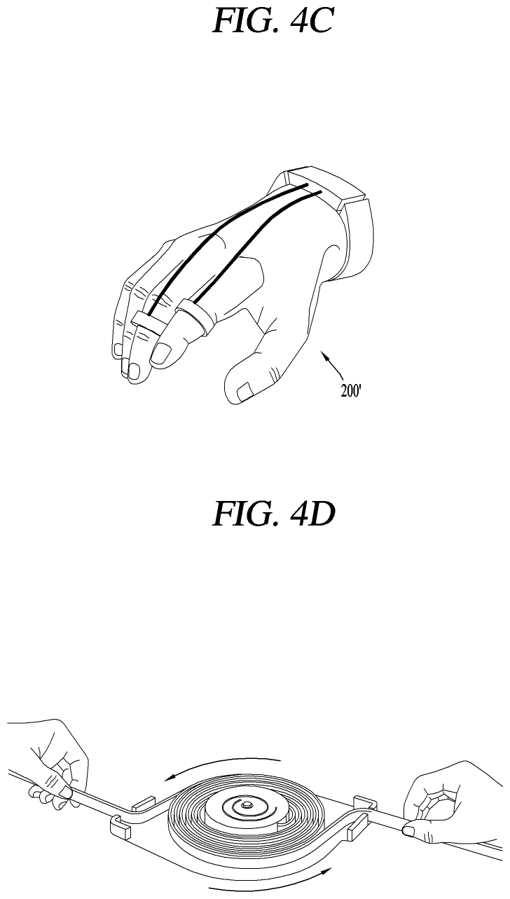

FIGS. 4A, 4B, 4C, and 4D are views for explaining a structure, exemplary components, and operating principles of the controller 200, 200′ communicating with the XR device 100 according to an embodiment of the present disclosure.

The controller 200 according to the present disclosure may be implemented in the form of a glove type that is worn on a knuckle side above a palm, as shown in FIG. 4A.

In still another embodiment, the controller 200′ according to the present disclosure may be implemented in the form of a bracelet type that is worn on a wrist like a watch, as shown in FIG. 4C.

Meanwhile, in FIG. 4C, for convenience of explanation, exemplary components of the controller have been described using the glove type controller 200 as an example, but the same components may also be applied to the bracelet type controller as well.

First, the controller 200 implemented in the form of a glove type will be described with reference to FIG. 4A.

The glove type controller may include a first portion in which a frame of a body is positioned and a second portion in which a plurality of rings that are worn on fingers are positioned. The first portion may include a mounting portion, which is a space in which major components such as a PCB or a battery are built, and a frame of the body, that is, the first portion, may be configured to wrap around above a user's palm, that is, proximal phalanges or phalanges of the fingers. Each of a plurality of rings included in the second portion may be connected to the mounting portion of the first portion via a wire so as to have a single connected structure. At least some of the plurality of rings may be provided with a haptic module for outputting an electrical vibration signal corresponding to the feedback signal. Each of the plurality of rings may be worn before or after a first joint of a corresponding finger. In this case, a ring and wire corresponding to a thumb position may be excluded for convenience of operation. Subsequent to fitting the plurality of rings onto the user's fingers, respective wire connected to the mounting portion are extended or contracted as the user takes a motion of extending or bending his or her fingers. Then, wire extension or contraction may be detected by the mounting portion to output a corresponding feedback signal through a haptic module included in each ring (or a haptic module mounted on the mounting portion). In addition, a signal/data corresponding to the detected wire extension or contraction may be transmitted to the connected XR device 100 through a communication module mounted inside or outside the mounting portion or body frame.

Next, the controller 200′ implemented in the form of a bracelet type will be described with reference to FIG. 4C.

In the bracelet type controller, the frame of the body including the mounting portion may be configured to be worn on the user's wrist like a watch. In this case, a ring worn in a fitted form on the user's finger and a wire configuration connecting between the ring and the mounting portion are similar to those of the glove type controller, but the shape of the ring is not a ‘c’ shape but a gourd shape, and the ring and wire may be configured only for some fingers (e.g., index and middle fingers) which are easy to detect wire extension or contraction. As the frame of the body is positioned above the user's wrist rather than on the user's palm like the glove-type controller, the bracelet type controller adopts a structure that excludes fingers which are difficult to detect wire extension or contraction, The bracelet type controller may also include other components identical to the aforementioned glove type controller, such as a battery, a haptic module, and a communication module.

Subsequently, with reference to FIG. 4B, the controller 200 (or controller 200′) may be implemented to include a front case 201, a rear case 202, a PCB 230 built into a space inside the cases, a motor 231 for generating vibration, one or more rings 222 worn in a fitted form on fingers, and one or more wires 221 connecting between the rings 222 and the mounting portion in which the PCB 230 and the like are built.

The PCB 230 is a hardware implementation of the processor 230 of the controller 200 described above, and may be understood as having the same configuration as the controller.

The motor 231 generates an electric vibration signal corresponding to a feedback signal, and may be implemented to generate the vibration signal directly from the mounting portion, or may be implemented to transmit the vibration signal to each ring connected through a wire so as to output the vibration signal from each ring. To this end, although not shown, a battery (not shown) for supplying power for the driving of the motor 230 in addition to the PCB 230 may be built into the mounting portion.

The ring 222 is worn in a fitted form around a first joint of the user's finger. The ring 222 may have the form of a ‘C’-shaped ring that is open in one direction (e.g., downward) for easy attachment and detachment. Additionally, the ring 222 may be implemented with a flexible material that can be easily bent before and after wearing, taking into account different finger sizes for different users. Each ring 222 is fitted onto the user's finger so as to be secured to each finger.

The wire 221 may be in the form of a cable with one end connected to the ring 222 and the other end connected to an inside of the mounting portion. The wire 221 is implemented to detect a change value in wire extension or contraction based on an initial value after wearing, taking into account the users' various hand sizes and finger lengths. For example, subsequent to connecting the controller 200 to the XR device 100, a finger motion of the user's hand (e.g., extending a finger, bending a finger, fully closing a finger, etc.) may be performed to set an initial value of the wire. An initial value of the wire according to the setting is stored in the memory (not shown), and then the extension or contraction of the wire is detected based on a wire length change value corresponding to the user's finger motion.

Meanwhile, although not shown, the mounting portion of the controller 200, 200′ may include a wire wheel module connected to one end (or the other end) of the wire. The wire 221 is wound around the wire wheel module, and is fixed by a torsion spring built into the wire wheel module.

FIG. 4D shows a principle of wire extension or wire contraction operation when the wire 222 is wound around the wire wheel module. In FIG. 4D, a torsion spring is built into the wire wheel module, and when the wound wire is pulled and withdrawn out of the mounting portion, it is recognized as wire extension. On the contrary, when the wire is released and withdrawn into the mounting portion, it is recognized as wire contraction.

In the present disclosure, the controller is implemented to be worn in a fitted form on the user's finger, and in a structure in which a wire is connected to a ring worn on the finger, when the user bends his or her finger, it is recognized that wire extension has occurred while the wire wound around the wire wheel module is pulled out. Furthermore, when the user extends his or her finger, it is recognized that wire contraction has occurred while the wire is wound into the wire wheel module.

To this end, the wire wound around the wire wheel module may have a structure in which one end is connected to a ring that fits over the user's hand, and the other end is wound in the form of a fixed cable around a torsion spring built into the wire wheel module.

The operation detection sensor of the controller detects wire extension when the wire is withdrawn out in a direction of the ring according to a bending motion of the finger wearing the ring. Additionally, the operation detection sensor of the controller detects wire contraction when the wire is withdrawn in a direction of the wire wheel module according to a motion of extending the finger wearing the ring.

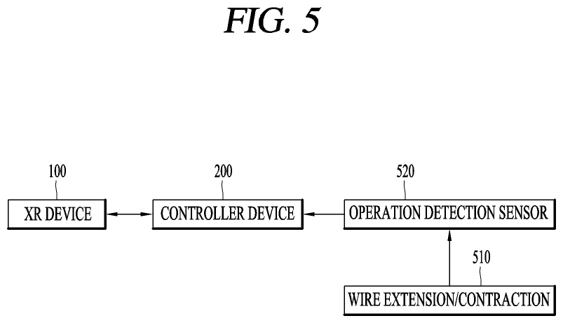

FIG. 5 is a diagram for explaining an operation in which the XR device 100 and the controller 200 interact based on operation detection data from the controller 200 according to an embodiment of the present disclosure.

As shown in FIG. 5, the XR device 100 and the controller device (hereinafter, ‘controller’) 200 are connected to perform mutual interaction through wired/wireless communication. The XR device 100 may track a position of a hand of a user wearing the controller through the second camera so as to generate and display a virtual object corresponding to a position and movement of the controller.

When the wire extension/contraction 510 of the controller 200 is performed through a hand motion of the user wearing the body, the controller 200 detects the performed wire extension/contraction through the operation detection sensor 520, thereby generating operation detection data corresponding to the wire extension or wire contraction.

The controller 200 transmits a signal/data corresponding to a result of the detection of the operation detection sensor 520, in particular, operation detection data corresponding to wire extension and/or operation detection data corresponding to wire contraction, to the XR device 100. The operation detection data may be transmitted continuously, and each operation detection data may include information on a magnitude of a sensing value corresponding to wire extension/contraction.

The XR device 100 may process the received operation detection data as input, perform image rendering processing on an interaction operation between a virtual object (e.g., a virtual hand) and a target object (e.g., a virtual ball), and output the rendered image through the display.

Specifically, the XR device 100 may receive operation detection data according to a motion of bending the hand wearing the controller as a first input and display a motion that maintains interaction with a target object. In addition, the XR device 100 may receive operation detection data according to a motion of extending the hand wearing the controller as a second input to display a motion of releasing or leaving the interaction with the target object.

For example, as operation detection data, while a virtual hand is gripping a virtual ball as wire extension is received at a first time point, an image of an interaction operation of throwing the gripped virtual ball is rendered as wire contraction is received at a second time point subsequent to the first time point, and displayed through the display 151.

A processing result of the XR device 100 (e.g., grabbing and throwing a virtual ball) may be transmitted to the controller 200, and the controller 200 may be operated to output a feedback vibration signal at a display time point corresponding to the processing result.

The XR device 100 may display an interaction-related motion for a target object of a VR image shown through the display 151 of the XR device 100 while a feedback vibration signal corresponding to the operation detection data is generated from the controller 200.

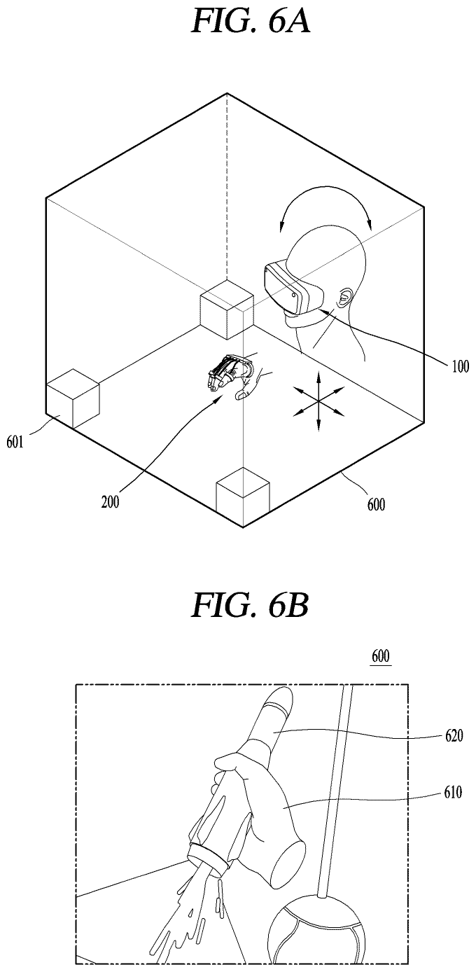

FIGS. 6A and 6B are views for explaining an interaction operation displayed on a VR image of an XR device through tracking a hand of a user wearing a controller according to an embodiment of the present disclosure.

In this specification, the XR device 100 identifies surrounding environment information (e.g., a front subject image) and the user's position through a general camera, that is, the first camera 121a. Additionally, the XR device 100 detects a position of the hand of the user wearing the controller 200 through a ToF camera, that is, the second camera 121b.

Specifically, the second camera 121b of the XR device 100 captures a point of the hand of the user wearing the controller 200 (e.g., an arbitrary point on a back of the hand, etc.) and transmits the captured point of the hand to the processor 180. The processor 180 may control the second camera 121b to acquire continuous images including a depth map of the user's hand based on the captured point.

Here, the depth map refers to an image containing information related to a distance from a viewpoint to a surface of an object in a three-dimensional computer graphic.

Meanwhile, as shown in FIG. 6A, it may be implemented that a plurality of lighthouse devices 601 are additionally provided in a space 600 so to more accurately recognize a position of the XR device 100. In this case, the lighthouse devices 601 may be provided at positions where a range of recognizable space 600 can be maximized, for example, at positions facing each other in a diagonal direction. The lighthouse devices 601 may each include an IR lamp and a two-axis motor, through which signals are exchanged with the XR device 100, so as to accurately determine a position of the XR device 100 based on a correlation between the position and time at which light reflected from the XR device 100 is received.

The XR device 100 may generate a VR image or XR object in the space 600 and output the generated VR image or XR object to the display based on surrounding environment information in the space 600, the position of the XR device, and the position and movement of the controller.

FIG. 6B shows an example of displaying an operation in which a virtual object (e.g., a virtual hand) 610 and a target object (e.g., a virtual flashlight) 620 interact in the space 600.

The XR device 100 recognizes the position of the XR device 100, that is, the user, in the space 600 through the first camera (i.e., a general camera), and recognizes the position of the controller 200, that is, the user's hand, in the space 600 through the second camera (i.e., a ToF camera).

While a corresponding feedback signal is generated from the controller 200 as a result of detecting wire extension/contraction corresponding to the hand motion (i.e., finger motion) of the user wearing the controller 200, the XR device 100 may perform rendering to display an interaction-related motion for a target object of a VR image provided to the display 151.

Specifically, the XR device 100 is controlled to capture a hand point of the user wearing the controller through the second camera. The XR device 100 may be controlled to acquire continuous images including a depth map of the user's hand based on the captured hand point of the user. The XR device 100 displays a virtual object (i.e., a virtual hand) 610 corresponding to the user's hand on the VR image based on the acquired continuous images.

For example, when wire extension is detected from the controller by a motion of bending a finger of the user wearing the controller 200, an interaction operation of gripping, by the virtual hand 610, an adjacent target object, that is, the virtual flashlight 620, in the space 600, is displayed as shown in FIG. 6B.

Additionally, although not shown, when wire contraction is detected from the controller by a motion of extending a finger of the user wearing the controller 200, an interaction operation of releasing or throwing, by the virtual hand 610, the virtual flashlight 620, may be displayed.

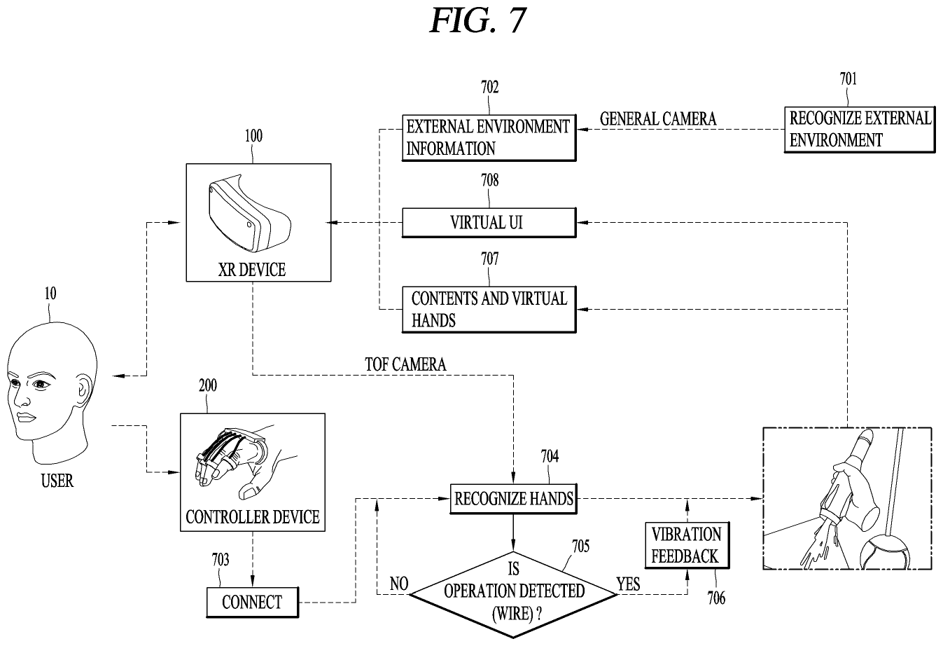

FIG. 7 is an operational flowchart associated with FIGS. 6A and 6B.

Referring to FIG. 7, while a user 10 wears the XR device 100 and the controller 200, an operation of interconnecting between the XR device 100 and the controller 200 (703) is carried out.

An interconnection between the XR device 100 and the controller 200 may be performed when detecting the wearing of the XR device 100 and the controller 200, after a predetermined period of time has elapsed subsequent to wearing, or in response to a preset input (e.g., a push of an input button on the XR device/controller device, a user motion, a voice command, etc.) subsequent to wearing.

The XR device 100 performs an operation of recognizing an external environment through the first camera, that is, a general camera (701) so as to collect external environment information (702). Furthermore, based on the collected external environment information, a position of the user wearing the XR device 100 is tracked.

In addition, the XR device 100 recognizes a hand of a user wearing the controller 200 through the second camera, that is, a ToF camera (704). At this time, the XR device 100 may acquire a depth map of the user's hand through the ToF camera, and generate a 3D virtual hand image by rendering the depth map on an original image of the user's hand.

When the hand of the user wearing the controller 200 is recognized, wire extension (corresponding to a motion of bending a finger) or wire contraction (corresponding to a motion of extending a finger) according to a motion of the user's hand, that is, a motion of bending or extending a finger, is detected. That is, it is determined whether operation detection data of the controller is generated (705). That is, a change in extension or contraction of a connected wire is detected according to a motion of the hand of the user wearing the controller.

When operation detection data corresponding to wire extension or wire contraction is generated, vibration feedback corresponding thereto is output from the controller 200 (706).

Even when no operation detection data corresponding to wire extension or wire contraction is generated, the XR device 100 continuously tracks the position of the user's hand through the second camera.

As such, when operation detection data corresponding to wire extension or wire contraction is generated or when vibration feedback corresponding thereto is output, the XR device 100 may display virtual content and a virtual hand interaction operation (707) and/or another virtual UI (708).

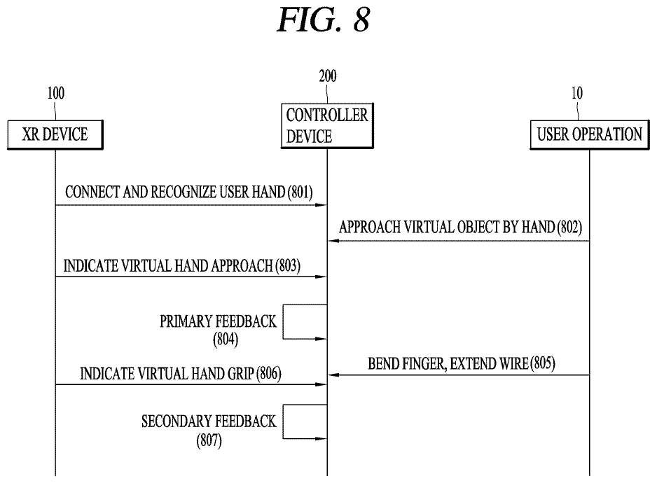

FIG. 8 is an exemplary flowchart for explaining an interaction operation displayed on a VR image of the XR device 100 based on wire extension detected by the controller 200 according to an embodiment of the present disclosure.

In other words, FIG. 8 shows operations related to approaching to interact with a virtual object using the controller 200.

As shown in FIG. 8, when the XR device 100 is connected to the controller device (hereinafter, ‘controller’) 200, the XR device 100 recognizes a position of a hand of a user wearing the controller using the second camera (e.g., ToF camera) provided in the XR device 100 (801).

The XR device 100 renders a virtual object (e.g., a virtual hand) corresponding to the user's hand based on an image including a depth map for the user's hand through the second camera, and displays the rendered image on a screen of the display 151.

The XR device 100 continuously tracks a position of the user's hand through the second camera to control a movement for a corresponding virtual object.

Then, as an operation of the user 10, in response to the user's hand approaching a target object in an image shown through the XR device 100 (802), the XR device 100 tracks the movement of the user's hand through the second camera to generate an image in which a corresponding virtual object approaches the target object. That is, the XR device 100 displays an indication of a virtual hand approaching a target object on a VR image, and transmits a signal/data corresponding to the indication to the controller 200 (803).

The controller 200 may output a feedback signal (hereinafter, ‘primary feedback’) in response to an indication that a virtual hand is approaching a target object (804).

Here, the primary feedback is a feedback signal indicating that the virtual hand has approached close to the target object that is intended to interact therewith. This primary feedback may be implemented in the form of, for example, outputting a low electrical vibration signal that can be felt slightly by the user through the output module 240 of the controller 200. The primary feedback may be a predetermined feedback output value in response to a proximity sensor recognizing that the user's hand has approached close to the target object.

Then, as an operation of the user 10, in response to detecting wire extension (or wire release) from the controller 200 as the user's hand takes a motion of bending a finger (805), the XR device 100 receives a signal corresponding to the wire extension as an input, and generates an image of a virtual object (e.g., a virtual hand) corresponding to the user's hand gripping a target object based on the received input. That is, the XR device 100 displays an indication that a virtual hand has gripped a target object on a VR image, and transmits a signal/data corresponding to the indication to the controller 200 (806).

The controller 200 may output a feedback signal (hereinafter, ‘secondary feedback’) simultaneously with or subsequent to displaying an indication that a virtual hand has gripped a target object (807).

Here, the secondary feedback is a feedback signal indicating that the virtual hand has touched and gripped the target object. The secondary feedback may be implemented, for example, in the form of outputting an electrical vibration signal that can be felt by the user that he or she has gripped a target object through the output module 240 of the controller 200, which may be a stronger electrical vibration signal than the primary feedback described above.

In an embodiment, a magnitude of an electrical vibration signal of the secondary feedback may be proportional to a magnitude of a sensing value of the detected wire extension. For example, when the user wearing the controller 200 takes a motion of bending a finger with a strong force, an output value of the electrical vibration signal may further increase as a sensing value of the wire extension increases.

In another embodiment, a magnitude or vibration pattern of the electrical vibration signal of the secondary feedback may vary depending on the properties of the target object.

For example, when the target object interacting with the virtual hand has the characteristics of a solid material (e.g., rock, stone, weapon, etc.), an electrical vibration signal value greater than a set value by a predetermined range may be output to the output module 240 of the controller 200. Alternatively, for example, when the target object interacting with the virtual hand has a soft tactile characteristic (e.g., a furry animal, etc.), an electrical vibration signal value smaller than the set value by a predetermined range may be output to the output module 240 of the controller 200. Alternatively, for example, when the target object interacting with the virtual hand is a material having elastic properties (e.g., a rubber ball, etc.), an electrical vibration signal having a pattern different from a reference pattern may be output.

According to an embodiment, the output module 240 that outputs electrical vibration signals of the first and second feedbacks may be at least one of a haptic module provided on each ring that is connected to one end of the wire and worn in a fitted form on the user's finger, and a haptic module built into the mounting portion positioned on a wrist/back of the hand.

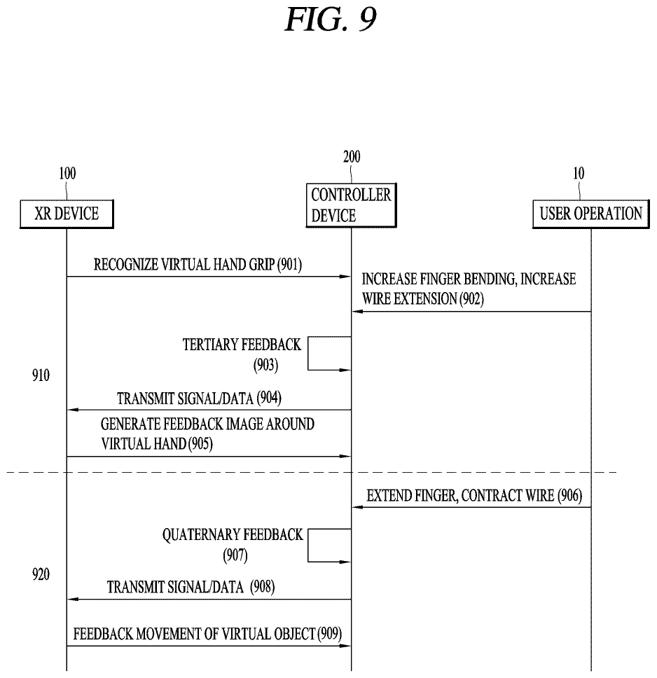

FIG. 9 is an exemplary flowchart for explaining an interaction operation displayed on a VR image of the XR device 100 based on an increase in wire extension (or an increase in wire tensile force) detected by the controller 200 according to an embodiment of the present disclosure.

In other words, subsequent to the operation of FIG. 8 described above, FIG. 9 shows an example of additional operations for a target object interacting using the controller 200 or operations related to releasing interaction.

As shown in FIG. 9, through the second camera of the XR device 100, a virtual hand corresponding to a hand of a user wearing the controller 200 that has gripped a target object may be recognized (901).

Then, as an operation of the user 10, in response to detecting an increase in wire extension by the controller 200 as the hand of the user wearing the controller 200 takes a motion of bending a finger more strongly (902), a tertiary feedback corresponding to the detected increase in wire extension may be output through the output module 240 of the controller 200. At this case, the tertiary feedback may be an electrical vibration signal having a higher output value than the secondary feedback indicating that the virtual hand has touched and gripped the target object.

Simultaneously therewith or subsequent thereto, a signal/data corresponding to an increase in wire extension is transmitted from the controller 200 to the XR device 100 (904).

The XR device 100 generates an extension feedback image around a virtual object corresponding to the user's hand (e.g., a virtual hand), the target device itself, or the virtual/target object based on the signal/data corresponding to an increase in wire contraction to project the generated image through the display 151. In addition, the XR device 100 transmits a signal/data corresponding to the extension feedback image to the controller 200 (905).

Here, the extension feedback image may include various types of images visually indicating that a virtual object corresponding to the user's hand strongly grips a target object. For example, an image indicating one of a change in shape of a target object (e.g., distortion), a change in color of a portion of a virtual/target object, or a movement of a position of a target object (e.g., bouncing off) may be rendered and output through the display 151 of the XR device 100.

Meanwhile, as another embodiment or as a subsequent operation of the user 10 to the operation (905), the hand of the user wearing the controller 200 may take a motion of extending a finger so as to detect wire contraction (906).

Subsequently, the controller 200 may output a quaternary feedback through the output module 240 in response to detection of wire contraction (907). In this case, the quaternary feedback indicates that the interaction is released by a virtual hand releasing or throwing a target object, and may be expressed as an electrical vibration signal with a fine output value similar to the primary feedback described above.

Simultaneously therewith or subsequent thereto, a signal/data corresponding to wire contraction is transmitted from the controller 200 to the XR device 100 (908).

Then, the XR device 100 generates a contraction feedback image around a virtual object corresponding to the user's hand (e.g., a virtual hand), the target device itself, or the virtual/target object based on the signal/data corresponding to wire contraction and outputs the generated image through the display 151.

Here, the contraction feedback image may include various types of images indicating that a virtual object corresponding to the user's hand releases or throws a target object. For example, an image indicating a change in position of a target object (e.g., falling or flying) or a change in position of a virtual object (e.g., extending a virtual hand or moving a position) may be rendered and output through the display 151 of the XR device 100.

Meanwhile, the contraction feedback image may be varied according to a magnitude of wire extension force prior to detecting wire contraction. For example, in a motion of throwing a virtual ball, wire contraction may cause a scene of throwing the ball to become a contraction feedback image, and may be implemented such that the greater the wire extension just prior to throwing, the greater the change in shape or travel distance of the thrown ball.

In addition, the XR device 100 may transmit a signal/data corresponding to the contraction feedback image to the controller 200 (909).

As described above, according to some embodiments of the present disclosure, a position of a user's hand including a depth map may be identified and tracked through a ToF camera provided on an XR device, without the need to have an LED ring on a controller in conjunction with the XR device, thereby generating a virtual object for interaction. The LED ring that takes up a significant portion of the controller may be removed, thereby contributing to reducing the size and weight of the controller. In addition, the controller is implemented in a form worn in a hand, the user does not need to continuously grip the controller while interacting with the XR device, thus freeing up both hands and making the operation more convenient. Moreover, the controller causes less fatigue even when used for a long period of time. In addition, when interacting with a target object provided through an XR device through a controller, feedback corresponding to a user's hand motion may be provided to the user's hand, thereby allowing the user to feel a more realistic interaction when interacting with a virtual object.

The above-described present disclosure may be implemented as computer-readable codes (or an application or software) on a program-recorded medium. The foregoing operating method of the XR device may be realized by codes stored in a memory or the like.

The computer-readable medium may include any type of recording device in which data readable by a computer system is stored. Examples of the computer-readable medium include a hard disk drive (HDD), a solid state disk (SSD), a silicon disk drive (SDD), a ROM, a RAM, a CD-ROM, a magnetic tape, a floppy disk, an optical data storage device and the like, and also include a device implemented in the form of a carrier wave (for example, transmission via the Internet). In addition, the computer may include a processor or controller. The above detailed description is therefore to be construed in all aspects as illustrative and not restrictive. The scope of the present disclosure should be determined by reasonable interpretation of the appended claims and all changes that come within the equivalent scope of the present disclosure are included in the scope of the present disclosure.

1. An XR device comprising:
a communication module that transmits and receives data to and from a controller;
a first camera for collecting external environment information and tracking a user's position and a second camera for tracking a position of a hand of the user wearing the controller;
a display that displays a virtual object corresponding to the hand on a VR image corresponding to the collected external environment information; and
a processor that tracks the position of the hand and processes the virtual object to move on the VR image so as to display the processed virtual object on the display,
wherein the processor receives operation detection data corresponding to a motion of the hand as input from the controller through the communication module, and processes the virtual object to perform an interaction-related operation with a target object of the VR image based on the received input so as to display the processed virtual object on the display.

2. The XR device of claim 1, wherein the processor controls the display to display an interaction-related operation for a target object of the VR image while a feedback signal corresponding to the operation detection data is generated from the controller.

3. The XR device of claim 1, wherein the first camera is a general camera and the second camera is a ToF camera.

4. The XR device of claim 3, wherein the XR device is a head-mounted display (HMD) device type that can be worn on the user's head, and
wherein, when worn, the first camera is positioned above both eyes of the user to scan a forward environment, and the second camera is positioned below the both eyes of the user to track the hand of the user wearing the controller.

5. The XR device of claim 4, wherein the processor controls a point of the hand of the user wearing the controller to be captured through the second camera, controls continuous images including a depth map of the user's hand to be acquired based on the captured point, and operates a virtual object corresponding to the hand to be displayed on the VR display based on the acquired continuous images.

6. The XR device of claim 1, wherein the received input is either one of a first input and a second input,
wherein the first input is operation detection data according to a motion of bending a hand wearing the controller, and the second input is operation detection data according to a motion of extending the hand, and
wherein the processor displays an operation that maintains the interaction when the first input is received and displays a motion that leaves the interaction when the second input is received.

7. A controller apparatus for an XR device, the controller apparatus comprising:
a body configured to be worn on a user's hand;
a communication module that transmits and receives data when connected to the XR device;
a sensor that detects a change in extension or contraction of a connected wire according to a motion of the hand of the user wearing the body;
a processor that transmits operation detection data corresponding to a change in extension or contraction of the connected wire to the XR device based on the hand of the user wearing the body being recognized through a camera of the XR device so as to interact with a VR image displayed on the XR device; and
an output module that outputs a feedback signal when an interaction with the VR image is performed based on the operation detection data.

8. The controller apparatus of claim 7, wherein the sensor detects, subsequent to wearing a ring, which is worn in a fitted form on the user's finger, while the ring and a wire wrapped around a wheel module are connected, wire extension corresponding to a motion of bending the finger or wire contraction corresponding to a motion of extending the finger, and transmits the detected wire extension or contraction to the processor.

9. The controller apparatus of claim 8, wherein the controller apparatus has a structure in which one end of the wire is connected to the ring, and the other end of the wire is wound in the form of a fixed cable around a torsion spring built into the wheel module, and
wherein the sensor operates to detect wire extension when the wire is withdrawn in a direction of the ring according to a motion of bending the finger, and detect wire contraction when the wire is withdrawn in a direction of the wheel module according to a motion of extending the finger.

10. The controller apparatus of claim 7, wherein the processor outputs vibration feedback through the output module while an operation of gripping a target object by a virtual object of the VR image is displayed based on the operation detection data.

11. The controller apparatus of claim 10, wherein when an increase in wire extension is detected by the sensor while an operation of gripping a target object by a virtual object of the VR image is displayed, a level of vibration feedback output through the output module is increased to transmit data related to the increase in wire extension to the XR device so as to display a feedback image around the target object of the VR image.

12. The controller apparatus of claim 10, wherein when wire contraction is detected by the sensor while an operation of gripping a target object by a virtual object of the VR image is displayed, a level of vibration feedback output through the output module is decreased to transmit data related to the wire contraction to the XR device so as to display a feedback movement for the target object of the VR image.

13. An operating method of an XR device, the method comprising:
connecting the XR device and a controller apparatus worn on a user's hand;
recognizing the hand of the user wearing the controller apparatus through a camera of the XR device;
detecting a change in extension or contraction of a connected wire according to a motion of the hand of the user wearing the controller apparatus; and
displaying an interaction-related operation on a VR image displayed on the XR device in response to receiving operation detection data corresponding to the detected change in the extension or contraction of the wire.
